(19) United States
(12) Patent Application Publication
(10) Pub. No.: US 2010/0119740 A1
(43) Pub. Date: May 13, 2010

(54) GLASS-TO-METAL BOND STRUCTURE

(75) Inventors: KEN BETTGER, PELLA, IA (US); ELLIOT BROWN, GOLDEN, CO (US); EDWARD N. BOULOS, TROY, MI (US); DAVID H. STARK, EVERGREEN, CO (US)

Correspondence Address: HOWISON & ARNOTT, L.L.P, P.O. BOX 741715, DALLAS, TX, 75374-1715, US

(73) Assignee: ELECTRONICS PACKAGING SOLUTIONS, INC., EVERGREEN, CO (US)

(21) Appl. No.: 12/580,381

(22) Filed: Oct. 16, 2009

Related U.S. Application Data
(60) Provisional application No. 61/106,461, filed on Oct. 17, 2008.

(51) Int. Cl. E06B 3/66; B32B 17/06; B32B 37/12; B32B 37/06

(52) U.S. Cl. 428/34; 428/432; 156/325

(57) ABSTRACT

A glass-to-metal bond structure comprises a metal substrate, a glass substrate and an oxide layer. The metal substrate is formed from a stainless steel alloy, a carbon steel, titanium, aluminum or copper. The glass substrate is formed from a soda-lime glass. The oxide layer is disposed between the metal substrate and the glass substrate, and includes iron oxide and chromium oxide. The oxide layer has an iron to chromium ratio within the range from 0.02 to 0.6 (atom ratio).

### CROSS-REFERENCE TO RELATED APPLICATIONS

This application claims the benefit of U.S. provisional application for patent Ser. No. 61/106,461, filed on Oct. 17, 2008, and entitled GLASS-TO-METAL BOND STRUCTURE, the specification of which is incorporated herein in its entirety.

### TECHNICAL FIELD

The following disclosure relates to insulating glass units of the type used in insulating window assemblies, and more particularly, to glass-to-metal bonds suitable for attaching glass panes to metal seals in vacuum insulating glass units.

### BACKGROUND

There exists a high level of interest in the development of highly-insulating glazing components for the purpose of reducing the energy use in all manner of buildings. The level of interest is strong because of the increasing cost of energy, energy policies and other incentives to conserve energy and the general worldwide focus on “Greening” and Global Warming.

### SUMMARY

In one aspect thereof, a glass-to-metal bond structure comprises a metal substrate, a glass substrate and an oxide layer. The metal substrate is formed from a stainless steel alloy, a carbon steel, titanium, aluminum or copper. The glass substrate is formed from a soda-lime glass. The oxide layer is disposed between the metal substrate and the glass substrate, and includes iron oxide and chromium oxide. The oxide layer has an iron-to-chromium ratio within the range from 0.02 to 0.6 (atom ratio).

In another aspect thereof, a vacuum insulating glass unit (“VIGU”) comprises a first glass pane formed of soda-lime glass, a second glass pane formed of soda-lime glass and spaced apart from the first glass pane, and a metal seal member extending around the periphery of the first and second glass panes and enclosing therebetween an evacuated volume. The metal seal member is hermetically sealed to each of the first and second glass panes with a glass-to-metal bond structure. The glass-to-metal bond structure has an oxide layer formed on the metal seal member including iron oxide and chromium oxide and having an iron-to-chromium ratio within the range from 0.02 to 0.6 (atom ratio).

In yet another aspect thereof, a method for forming a glass-to-metal bond structure comprises providing a metal substrate and providing a glass substrate. An oxide layer is formed on the metal substrate. The oxide layer includes iron oxide and chromium oxide and has an iron-to-chromium ratio within the range from 0.02 to 0.6 (atom ratio). The metal substrate is heated to a first temperature within the range from 500° C. to 1000° C. and the glass substrate is heated to a second temperature within the range from 500° C. to 1000° C., and then the oxide layer on the metal substrate is placed in contact with the glass substrate until a bond is formed.

### BRIEF DESCRIPTION OF THE DRAWINGS

For a more complete understanding, reference is now made to the following description taken in conjunction with the accompanying Drawings in which:

FIG. 1 is a perspective view, with portions broken away, of a VIGU in accordance with one embodiment;

FIG. 2 is a side view of a glass-to-metal bond structure in accordance with one embodiment;

FIG. 3 is a top view of the glass-to-metal bond structure of FIG. 1; and

FIG. 4 is an illustration of a tested embodiment of a glass-to-metal bond structure.

### DETAILED DESCRIPTION

Referring now to the drawings, wherein like reference numbers are used herein to designate like elements throughout, the various views and embodiments of a glass-to-metal bond structure are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

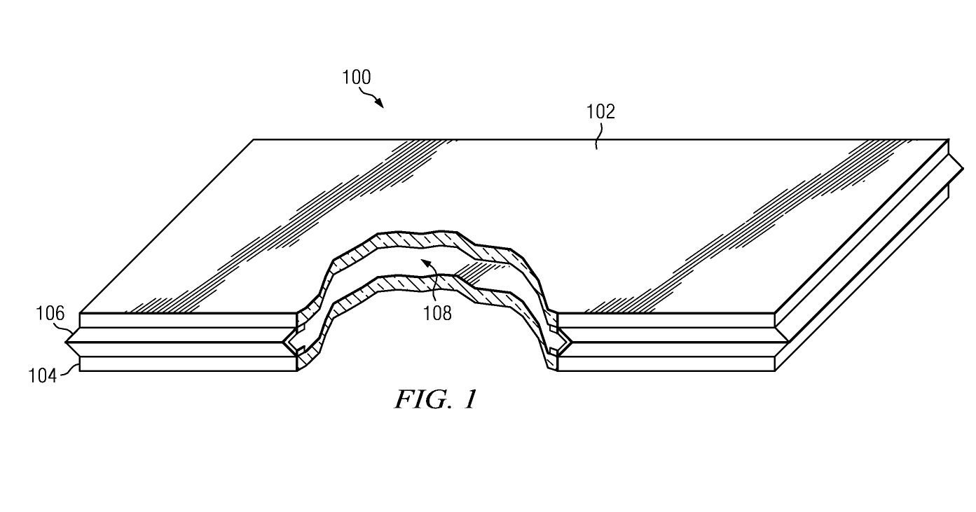

Aspects of the invention include vacuum insulating glazing units (also referred to as “VIGUs”), material-to-material bond structures useful in connection with VIGUs, and methods for producing bond structures and VIGUs. Referring now to FIG. 1, there is illustrated a VIGU in accordance with one embodiment. The VIGU 100 comprises two spaced-apart pieces of glass 102 and 104, sealed by a seal member 106 around the periphery and enclosing therebetween an evacuated volume 108. A plurality of spacer members (not shown) may be disposed within the evacuated volume 108 to maintain the separation between the glass pieces 102 and 104. The seal member 106 is hermetically sealed to the glass pieces 102 and 104. The seal member 106 may be formed of a single article or it may comprise multiple articles that are hermetically joined to form the seal. In some embodiments, the seal member 106 is formed of a metal or metallic alloy, and in such embodiments the hermetic seal between the seal member and the glass pieces 102 and 104 may be a glass-to-metal bond.

Another aspect comprises a glass-to-metal bond structure that has the capability of joining soda-lime glass to a commercially-produced metal substrate. Such a glass-to-metal bond structure can be used in the manufacture of VIGUs as described above, however, it will be appreciated that the utility of such glass-to-metal bond structures is not limited to VIGUs. In the VIGU context, the metal substrate may form a flexible metal edge seal (e.g., seal member 106) around the VIGU, to allow the inner and outer panes of glass (e.g., glass pieces 102 and 104) of the VIGU to expand and contract independently as a function of various temperature conditions. The combined glass-to-metal bond structure and the flexible metal edge seal produce a barrier to all molecules in the natural environment (molecular barrier) to the extent that a vacuum pressure described as 10⁻³ Torr or lower can be maintained in the enclosed volume (e.g., volume 108) of the VIGU for a minimum of 40 years. In preferred embodiments, a vacuum pressure described as 10⁻³ Torr or lower can be maintained in the enclosed volume of the VIGU for a minimum of 50 years. This description of the “molecular barrier” represents a key point of differentiation from prior work that refers to a “hermetic” seal in the context of excluding water vapor from a gas-filled enclosed space.

In another aspect, the inventors have developed a procedure for developing and characterizing the required features of the glass-to-metal bond structure, flexible metal edge seal and ultimately the full-scale, fully-functional VIGU component. This involves new methods of development and characterization of a subsection of the full-sized glass-to-metal seal, which is denoted glass-to-metal bond structure.

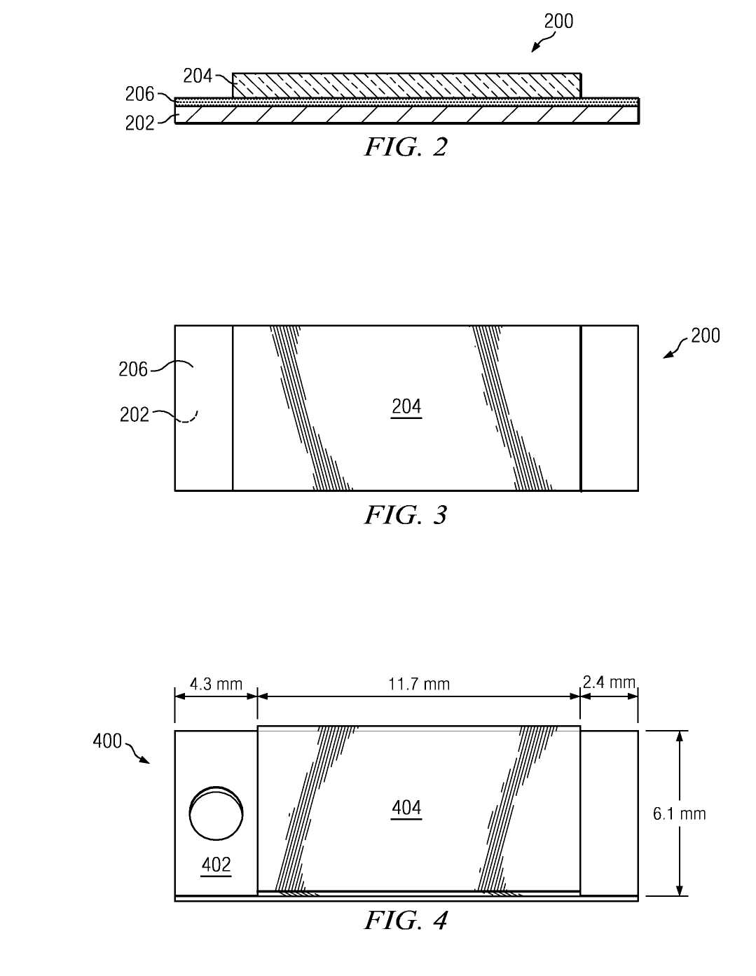

Referring now to FIGS. 2 and 3, there is illustrated an embodiment of glass-to-metal bond structure in accordance with another embodiment. The glass-to-metal bond structure 200 includes a metal substrate 202, a glass substrate 204 and an oxide layer 206. The thicknesses of the various elements shown in FIG. 1 have been exaggerated for purposes of illustration.

Metal Substrate: The metal substrate material 202 has a thickness in this documented embodiment of 0.020 inches, but may range from 0.005 inches to 0.040 inches. The preferred material is Allegheny Ludlum alloy 29-4C as included in this example, but may include other stainless steel alloys, carbon steels, titanium, aluminum and copper as well.

Glass Substrate: The glass substrate material 204 in this documented embodiment is soda-lime glass, which has been purchased in the US commercial marketplace and represents a certain combination of chemical constituents and process conditions produced in a float-glass plant located in the US. The new glass-to-metal bond structure 200 may include the capability to produce the required “molecular barrier” within the full-expected range of variation in soda-lime glass properties that may be found in the US, Europe, Asia and the rest of the world.

Metal Substrate Surface Preparation: The metal substrate 202 in this documented embodiment has been prepared in a new manner to increase the effectiveness of the glass-to-metal bond. The bond area has been abraded, using water-flooded, 240-grit abrasive medium, followed by thorough cleaning, using ultrasonic agitation in hot de-ionized water.

Oxide Layer: An oxide layer 206 was formed on the metal substrate surface 202 in the documented embodiment. The oxide layer 206 may include both iron oxide(s) and chromium oxide(s). In one embodiment, the oxide layer 206 was formed by heating the metal substrate 202 at 1050° C. in a retort furnace using a wet hydrogen atmosphere (dew point of +20° C.) at normal atmospheric pressure for a time of 30 to 60 minutes. The weight gain per unit area, produced by the oxide layer may range from 80 μg/cm² to 320 μg/cm², but falls within the range of 185 μg/cm² to 280 μg/cm² in this documented embodiment. The iron to chromium ratio of the oxide layer may range from 0.02 to 0.6 (atom ratio), but falls into the range of 0.02 to 0.07 (atom ratio) in this documented embodiment.

Bond Formation: After formation of the oxide layer 206 on the metal substrate 202, the oxidized metal substrate is bonded to the glass substrate 204 by means of a glass-to-metal bond. The glass-to-metal bond has been accomplished in a short period of time, ranging from 10 seconds to 10 minutes as a function of temperature and pressure conditions produced in the process furnace. The glass substrate 204 and metal substrate 202 were selectively and differentially heated in the range of 500° C. to 1000° C. to produce maximum strength at the interface. The bonding time in this documented embodiment was 5 minutes. In preferred embodiments, the metal substrate 202 is heated to a temperature materially greater (i.e., at least 10 percent greater measured in ° C.), than the temperature of the glass substrate 204. For example, in one embodiment, the metal substrate 202 was heated to a temperature of about 760° C. and the glass substrate was heated to a temperature of about 650° C. at bonding. In other embodiments, the metal substrate is heated to a first temperature within the range of 760° C. to 650° C. and the glass substrate 204 is heated to a lower second temperature within the range of 650° C. to 600° C. at bonding. After bonding, the newly created glass-to-metal bond structure 200 is allowed to cool back to room temperature.

Referring now to FIG. 4, there is illustrated a glass-to-metal bond structure in accordance with a tested embodiment. The glass-to-metal bond structure 400 includes a metal substrate 402, a glass substrate 404 and an oxide layer (not visible) substantially as described above. The glass-to-metal bond extends continuously beneath the glass substrate 404. The dimensions shown in FIG. 4 correspond to the size of the tested embodiment.

It will be appreciated by those skilled in the art having the benefit of this disclosure that this glass-to-metal bond structure provides a useful bond configuration and a useful bonding method for bonding glass to metal. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A glass-to-metal bond structure comprising:
a metal substrate formed from one of a stainless steel alloy, a carbon steel, titanium, aluminum and copper;
a glass substrate formed from a soda-lime glass; and
an oxide layer disposed between the metal substrate and the glass substrate, the oxide layer including iron oxide and chromium oxide and having an iron-to-chromium ratio within the range from 0.02 to 0.6 (atom ratio).

2. A vacuum insulating glass unit comprising:
a first glass pane formed of soda-lime glass;
a second glass pane formed of soda-lime glass and spaced apart from the first glass pane;
a metal seal member extending around the periphery of the first and second glass panes and enclosing therebetween an evacuated volume;
wherein the metal seal member is hermetically sealed to each of the first and second glass panes with a glass-to-metal bond structure having an oxide layer formed on the metal seal member including iron oxide and chromium oxide and having an iron-to-chromium ratio within the range from 0.02 to 0.6 (atom ratio).

3. A method for forming a glass-to-metal bond structure comprising the steps:
providing a metal substrate;
providing a glass substrate;
forming an oxide layer on the metal substrate, the oxide layer including iron oxide and chromium oxide and having an iron-to-chromium ratio within the range from 0.02 to 0.6 (atom ratio); and
heating the metal substrate to a first temperature within the range from 500° C. to 1000° C. and the glass substrate to a second temperature within the range from 500° C. to 1000° C. and placing the oxide layer on the metal substrate in contact with the glass substrate until a bond is formed.

4. A method in accordance with claim 3, wherein the first temperature is at least ten percent (10%) greater than the second temperature when the oxide layer on the metal substrate is placed in contact with the glass substrate.
